(19) United States
(12) Patent Application Publication
(10) Pub. No.: US 2006/0215637 A1
(43) Pub. Date: Sep. 28, 2006

(54) Visual communication server, visual communication program and visual communication method

(76) Inventors: Shigeru Fukazawa, Hachioji-shi (JP); Yasumasa Sasaki, Tachikawa-shi (JP); Koji Shima, Sagamihara-shi (JP); Fumikazu Matsukawa, Oume-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/243,680

(22) Filed: Oct. 4, 2005

(30) Foreign Application Priority Data
Mar. 22, 2005 (JP) P2005-081252

(51) Int. Cl. H04L 12/66

(52) U.S. Cl. 370/352

(57) ABSTRACT

A VC server 1 has a call management unit 14 which detects a line connection state of telephone terminals based on an event signal received from an exchange 3 and registers the line connection state in a call information DB 11, a client information DB 10 in which telephone numbers of the telephone terminals and IDs of VC clients are stored in correspondence, a client connection information DB 12 in which session states between VC clients are stored, and a client session controller 15 which, when a change in line state between the telephone terminals is detected in the call information DB 11, refers to the client information DB 10, specifies a pair of corresponding VC clients, and instructs to establish or terminate a session between the VC clients according to the change in line state.

### CROSS-REFERENCE TO RELATED APPLICATIONS

This application is based upon and claims the benefit of priority from the prior Japanese Patent Application No. 2005-81252, filed on Mar. 22, 2005; the entire contents of which are incorporated herein by reference.

### BACKGROUND

1. Field of the Invention

The present invention relates to a visual communication server, a visual communication program, and a visual communication method which realize a visual communication function using, for example, an existing telephone system and computer system.

2. Description of the Related Art

Hitherto, there is a telephone system as means for communicating person to person. In recent years, along with improvement of network technologies, person-to-person communication has been developing into a form of using not only voices but also images in combination, in other words, a television conference system.

A conventional television conference system is a system such that a dedicated apparatus (a communication control apparatus such as a set top box) and a combined device of a microphone and a camera are placed in a television telephone conference room in each of locations (offices or the like) dotted around several regions, and the locations are connected by INS lines or private IP lines to thereby communicate voices and images.

In this television conference system in the form including dedicated apparatuses, it is necessary to installed large equipment in each location for constructing the system. In addition, even if the television conference system is installed, a user must learn how to operate the dedicated apparatus, and therefore it is difficult to be installed as a television telephone.

On the other hand, in recent years, there are emerging systems with which a form of television conference can be easily constructed by installing client software for television conference in a computer and combining it with a dedicated telephone having a voice function for holding a television conference.

Such a television conference system in the form using client software for television conference installed in a computer can be installed easier than the previously described system, but there is a problem of increasing cost because it requires one dedicated telephone to be connected to, in other words, prepared for each computer.

Accordingly, it is conceivable to utilize an existing telephone system that is already maintained as an infrastructure.

As a prior art utilizing an existing telephone system, for example, there already exists a technique that enables cooperation of a private branch exchange and a server so that an incoming call to an extension telephone can be also notified to a client terminal (for example, refer to Japanese Patent Laid-open Application No. 2003-179687).

### SUMMARY

However, in the case of the above-described prior art, the server only has a function to relay an incoming call to an extension telephone to a client terminal, and only voice calls can be communicated.

Accordingly, to realize a communication function of voices and images, any one of the above-described television conference system needs to be installed, and eventually, this poses a problem of high cost and difficulty in usage.

The present invention is made to solve such problems, and an object thereof is to provide a visual communication server, a visual communication program, and a visual communication method capable of realizing a visual communication function using an existing telephone system and computer system simply with low cost.

A visual communication server according to an embodiment of the present invention is a visual communication server coupled to an exchange which controls a line connection between telephone terminals and to client computers arranged corresponding to the respective telephone terminals so as to perform communication of visual data imaged by a camera, and the visual communication server has: a call information event receiving unit which receives from the exchange a call information event generated by a behavior of the telephone terminal; a telephone terminal state detecting unit which detects a line state between the telephone terminals based on the call information event received by the call information event receiving unit; and a controller which establishes or terminates according to the line state between the telephone terminals detected by the telephone terminal state detecting unit a session for the visual data communication between the client computers arranged corresponding to the telephone terminals.

A visual communication program according to an embodiment of the present invention is a visual communication server configured to execute processes in a visual communication server coupled to an exchange which controls a line connection between telephone terminals and to client computers arranged corresponding to the respective telephone terminals so as to perform communication of visual data imaged by a camera, and the visual communication program includes functions where the visual communication server receives from the exchange a call information event generated by a behavior of the telephone terminal; detects a line state between the telephone terminals based on the received call information event; and establishes or terminates according to the detected line state between the telephone terminals a session for the visual data communication between the client computers arranged corresponding to the telephone terminals.

A visual communication method according to an embodiment of the present invention is a visual communication method for a visual communication server coupled to an exchange which controls a line connection between telephone terminals and to client computers arranged corresponding to the respective telephone terminals so as to perform communication of visual data imaged by a camera, and the visual communication method includes: receiving from the exchange a call information event generated by a behavior of the telephone terminal; detecting a line state between the telephone terminals based on the received call information event; and establishing or terminating according to the detected line state between the telephone terminals a session for the visual data communication between the client computers arranged corresponding to the telephone terminals.

### BRIEF DESCRIPTION OF THE DRAWINGS

FIG. 1 is a view showing an overall configuration of a visual communication system according to an embodiment of the present invention.

FIG. 2 is a view showing the configuration of a VC server of the visual communication system shown in FIG. 1.

FIG. 3 is a view showing contents of a client information DB.

FIG. 4 is a view showing contents of a call information DB.

FIG. 5 is a view showing contents of a client connection information DB.

FIG. 6 is a view showing an example of an event signal with respect to an operation of a telephone terminal.

FIG. 7 is a flowchart showing processes of a VC server for controlling a video connection.

FIG. 8 is a communication sequence diagram for starting a video session between two VC clients.

FIG. 9 is a communication sequence diagram for starting a video session between three VC clients.

### DETAILED DESCRIPTION

### Description of Embodiments

Embodiments of the present invention will be described with reference to the drawings, but these drawings are presented only for an illustrative purpose and in no way limit the present invention.

In the visual communication server according to an embodiment of the present invention, when a call information event outputted by an exchange is received by the visual communication server, the visual communication server detects a line state between telephone terminals based on the call information.

Also, according to the detected line state between telephone terminals, the visual communication server establishes or terminates a connection for visual data communication between client computers arranged corresponding to these telephone terminals.

The visual communication server detects a line state between telephone terminals as a connected state when the call information event is, for example, a line connection event such as “talking” indicating an off-hook state of two or more telephone terminals and “ringing” indicating a ringing state thereafter.

When the call information event is “dropped” indicating termination of a line connection of a telephone terminal, the visual communication server detects a line state between relevant ones among the telephone terminals as a disconnected state.

Moreover, when the call information event is “held” indicating a temporary holding of a telephone call in a telephone terminal, the visual communication server detects a line state between relevant ones among the telephone terminals as a held state.

Then, the visual communication server instructs to establish or terminate a session between client computers according to the detected line state between telephone terminals, so that a user becomes able to start a television conference automatically by a regular telephone operation without preparing a dedicated telephone.

Also, when a line connection of three or more telephone terminals is detected, the visual communication server generates a pair of every two telephone terminals among them, and sequentially establishes a session between client computers corresponding to each pair, so that it can respond to a multiple call among three or more persons.

Hereinafter, with respect to the above description, an embodiment of the present invention will be described in detail with reference to the drawings.

### First Embodiment

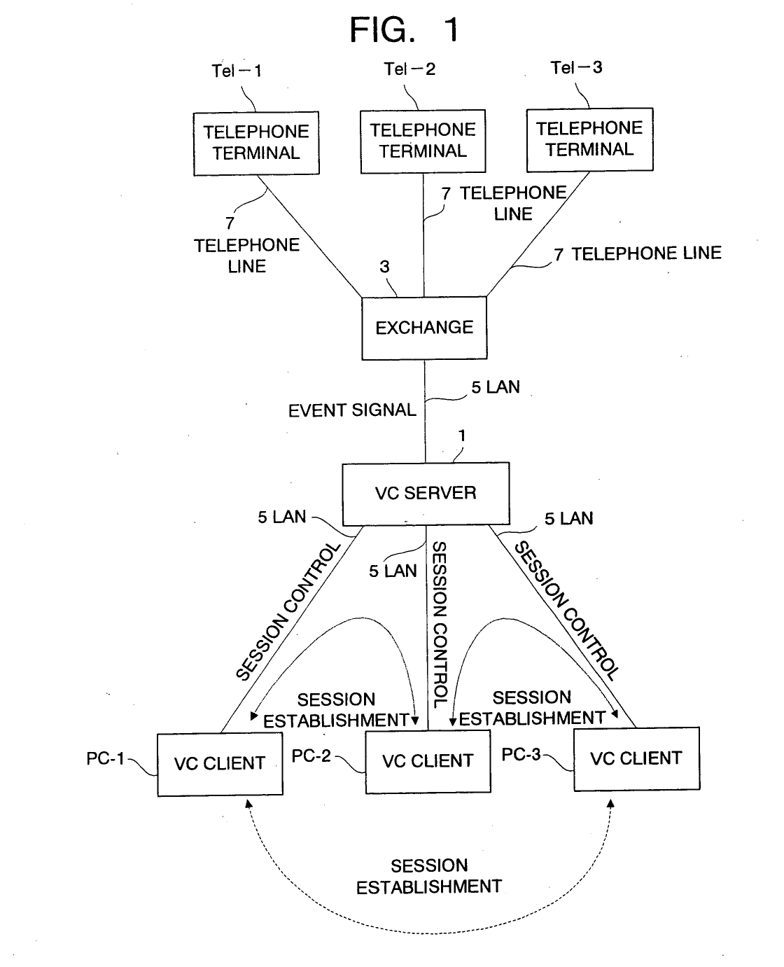

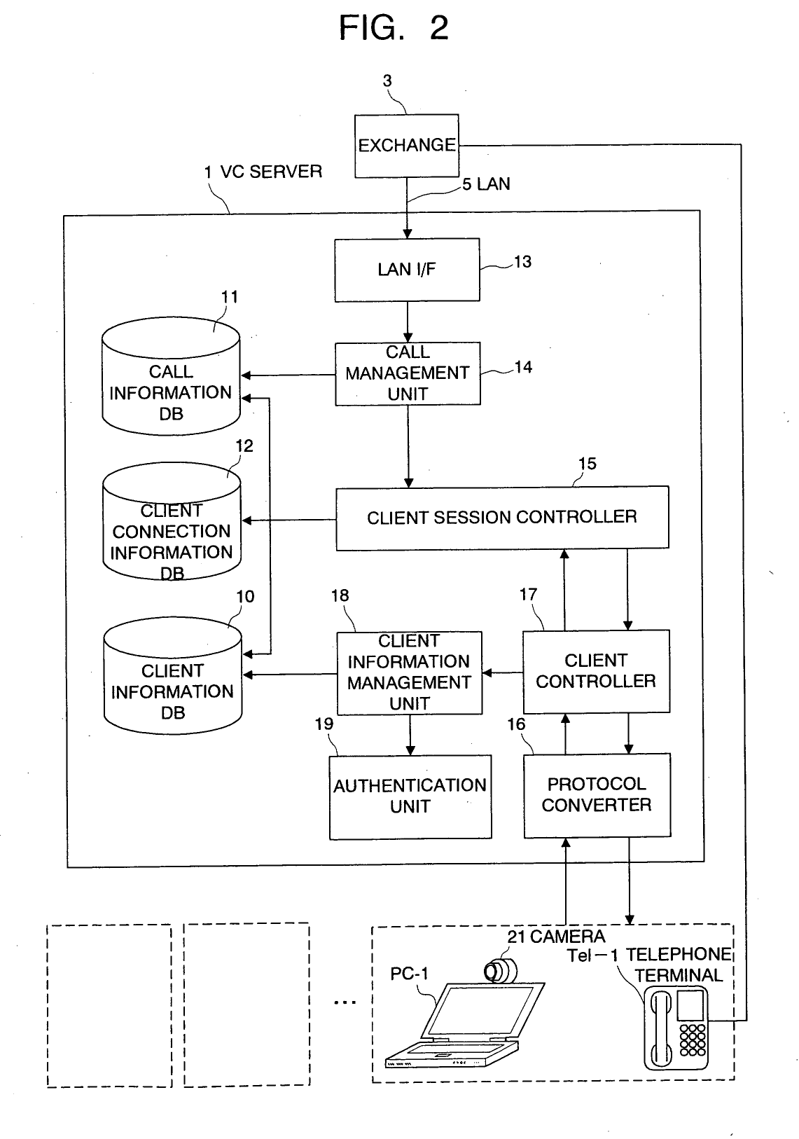

As shown in FIG. 1 and FIG. 2, the visual communication system of this embodiment has an exchange 3, telephone terminals Tel-1 to Tel-3 connected to the exchange 3 via telephone lines 7, a visual communication server 1 (hereinafter referred to as a VC server 1) as a server computer connected(coupled) to the exchange 3 via, for example, an IP network such as a local area network (hereinafter referred to as LAN 5), and visual communication clients PC-1 to PC-3 (hereinafter referred to as VC clients PC-1 to PC-3) as client computers connected to the VC server 1 via the LAN 5.

The exchange 3 constantly applies a pulse voltage to the telephone terminals Tel-1 to Tel-3 via the telephone lines 7, and detects behaviors of the telephone terminals Tel-1 to Tel-3 based on the changes of a pulse wave according to a manipulation (on-hook, off-hook) by a user to the telephone terminals Tel-1 to Tel-3 or an operation thereof.

In other words, the exchange 3 detects behaviors of the telephone terminals Tel-1 to Tel-3 via the telephone lines 7 and carries out a line exchange procedure according to detected behaviors.

On a telephone terminal, when a receiver is picked up from a terminal main body, in other words, off-hooked, and ringing to a destination telephone terminal is performed by dialing (transmission of a telephone number: ringing), the exchange 3 detects that the telephone terminals become off-hook with each other and turns them to a voice communication capable state.

Behaviors of the telephone Tel-1 to Tel-3 include, for example, “talking” indicating an off-hook state, “ringing” indicating a state of making a telephone call, “dropped” indicating an on-hook state, “held” indicating a temporary holding state, and so on.

“Talking” as an off-hook state is a state that a hook switch closes a circuit when a user picks up a receiver from a terminal main body.

Also, “talking” as an off-hook state is a state that a person called by the user picks up a receiver from a terminal main body and answered, thereby turning into a calling state.

“Dropped” as an on-hook state is a state that the user puts down (placed) the receiver on the terminal main body and then the hook switch opens the circuit.

Also, “dropped” as an on-hook state refers to a state that a receiver is put down by either user when telephone terminals are connected on-line to each other and after this time point.

“Ringing” indicating a state of making a telephone call is a state of making a telephone call from one telephone terminal to another telephone terminal, and the exchange 3 detects this state as a behavior of each telephone terminal.

Specifically, the behavior “ringing” indicating a state of making a telephone call includes, on the calling side, a dialing operation on a telephone terminal, and includes, on the receiving side, an operation of a telephone terminal such as a ringing operation.

In other words, the behaviors of calling and receiving are behaviors of each of the telephone terminals Tel-1 to Tel-3 of making, receiving and terminating a telephone call between the telephone terminals Tel-1 to Tel-3.

The telephone terminals Tel-1 to Tel-3 each have a receiver and a terminal main body. In the terminal main body, there are provided a hook switch which detects picking up and putting down of the receiver, dial keys, a calling unit which accepts a dialing operation with the dial keys after the hook switch is off-hooked and makes a call to a calling destination, a receiving unit which performs a ringing operation when a call is received and carries out a call when the hook switch is off-hooked, and so on.

In the receiver, there are provided a speaker which outputs the voice of a called person during a call, a microphone which collects the voice of a speaker during a call, and so on.

Each of the VC clients PC-1 to PC-3 is a general computer having a CPU, a memory, a display, a keyboard, a mouse, a hard disk device, a LAN interface (hereinafter referred to as a LAN I/F), a USB interface (hereinafter referred to as a USB I/F), and so on.

To the USB I/F, a camera 21 is connected. The camera 21 is directed forward so as to image the head, shoulders, and upper chest of a person located in front of each of the VC clients PC-1 to PC-3 and fixed to each of the VC clients PC-1 to PC-3. To the LAN I/F, the LAN 5 is connected.

The camera 21 is a camera for video chatting of a USB connection type, which has a few hundred thousands of pixels.

Incidentally, as the camera 21, there is also a type that is embedded in the computer main body or a display part.

In the hard disk device, there is installed client software which displays a screen for television conference to realize a visual communication function, and capturing an image (picture) of a speaker imaged by the camera 21 and transmitting the image to the VC server 1.

In the memory, a client ID that is identification information assigned to a VC client in advance and a telephone number that is identification information of a telephone terminal to be correlated are registered in correspondence as client information.

Functions of the client software include a communication function with the VC server 1 and a registration function to the VC server 1, and these functions are realized by cooperation of the CPU with memory and so on.

The communication function with the VC server 1 performs transmission/reception of signals regarding control of a session to/from the VC server 1, and transmission/reception for registering client information such as a client ID and a corresponding telephone number in the memory to/from the VC server 1.

Specifically, on each of the VC clients PC-1 to PC-3, SIP (session Initiation Protocol) is mounted for performing communication in an application layer such as session control and registration of client information.

To transmit/receive a message of SIP between each of the VC clients PC-1 to PC-3 and the VC server 1, communication via the LAN 5 with the VC server 1 is performed by TCP/IP provided in OS.

The registration function to the VC server 1 is a function of reading client information registered in the memory in advance and registering it in the VC server 1 at predetermined timing, and this function is performed by the CPU of each of the VC clients PC-1 to PC-3.

The predetermined timing is, for example, the time when a user's startup operation starts the client software.

The CPU of each of the VC clients PC-1 to PC-3 accesses the VC server 1 via the LAN 5 and performs a registration operation at this timing.

Besides, the CPU may be configured to register the client information in the VC server 1, by a user's clicking operation on an execution button of registration to the VC server 1 being a trigger, in a registration screen shown on the display when the client software is started.

When the CPU of each of the VC clients PC-i to PC-3 registers client information in the VC server 1, a telephone number to be correlated with a client ID registered in advance in the memory is transmitted (notified) as client information from each of the VC clients PC-1 to PC-3 to the VC server 1.

On the VC server 1 side, the client information received from each of the VC clients PC-1 to PC-3 is stored (registered) in a client information DB 10, which is a table correlating telephone terminals and VC clients.

The VC server 1 is connected via the LAN 5 to the exchange 3 which controls calls between the telephone terminals Tel-1 to Tel-3 and to the VC clients PC-1 to PC-3 arranged respectively at positions of the telephone terminals Tel-1 to Tel-3 for performing visual communication and each having a camera 21 connected thereto.

Such a camera 21 is also referred to as a PC camera as a different type from ones that store images in an internal memory.

Each of the VC server 1 and VC clients PC-1 to PC-3 is a computer having a CPU, a memory, a display, a keyboard, a mouse, a hard disk device, a LAN interface (hereinafter referred to as a LAN I/F), and so on.

In the hard disk device, an operating system (hereinafter referred to as OS) and server software are installed. Software such as the OS and the server software and the above-described hardware cooperate with each other to realize a visual communication function according to the present invention.

Specifically, in the VC server 1, as shown in FIG. 2, a call information data base 11 (hereinafter referred to as a call information DB 11), a client information data base 10 (hereinafter referred to as a client information DB 10), a client connection information data base 12 (hereinafter referred to as a client connection information DB 12), a LAN I/F 13, a call management unit 14, a client session controller 15, a protocol converter 16, a client controller 17, a client information management unit 18, an authentication unit 19, and so on are provided.

The client information DB 10, the call information DB 11, the client connection information DB 12, and so on are configured inside the hard disk device or the memory.

The CPU develops in the memory the OS and server software installed in the hard disk device and realizes functions such as the above-described LAN I/F 13, call management unit 14, client session controller 15, protocol converter 16, client controller 17, client information management unit 18, and authentication unit 19.

The LAN I/F 13 and the call management unit 14 function as a call information event receiving unit which receives from the exchange 3 via the LAN 5 a call information event (hereinafter referred to as an event signal) generated by a series of behaviors such that, the telephone terminals Tel-1 to Tel-3 change from an on-hook state to an off-hook state, a call is made to another telephone terminal, the called person picks up the receiver to answer the call, the receiver is put down thereafter, and then the telephone terminals get back to the on-hook state.

The call management unit 14 receives an event signal from the exchange 3 and performs a data edit operation (new registration, delete, and update) with respect to the call information DB 11.

Specifically, the call management unit 14 functions as a telephone terminal state detection unit which detects, based on the event signal received from the exchange 3, an off-hook (talking) state, a state of making a telephone call (ringing), a state of temporarily holding a telephone call (held), or an on-hook (dropped) state of relevant one among the telephone terminals Tel-1 to Tel-3.

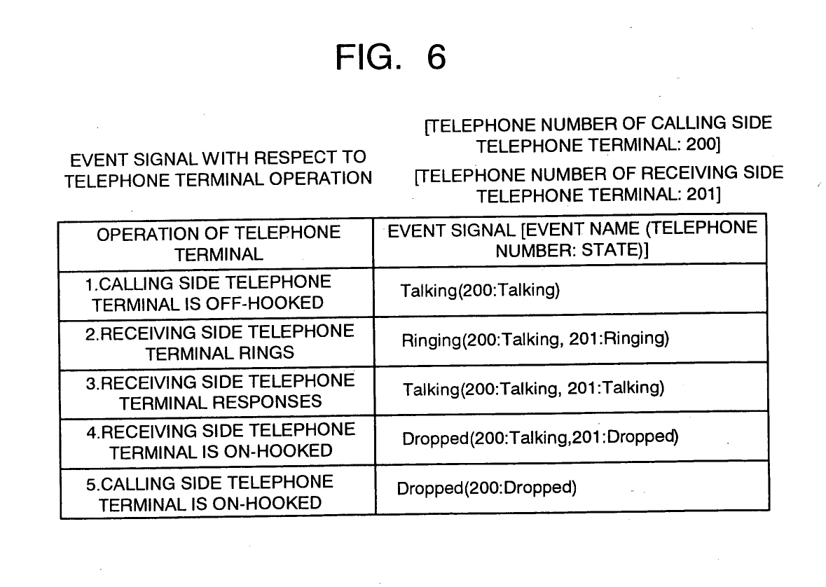

For example, the call management unit 14 detects the line state between telephone terminals as a “connected state” when the event signal received from the exchange 3 is one showing a line connection state between two or more telephone terminals, that is “talking (200: talking, 201: talking)” of 3. in FIG. 6.

The call management unit 14 also detects the line-state between the relevant telephone terminals as a “disconnected state” when the event signal received from the exchange 3 is one showing termination of a line connection, that is a state that the called person is on-hooked the receiver, that is “dropped (200: talking, 201: dropped)” of 4. in FIG. 6.

Moreover, the call management unit 14 detects the line state between the relevant telephone terminals as a “temporary holding state” when the event signal received from the exchange 3 is one showing a state of temporarily holding a telephone call from a telephone terminal, that is “held (200: held, 201: talking).”

The client session controller 15 receives information from the call management unit 14, refers to the call information DB 11 to obtain relevant data, performs a data editing operation (new registration, delete, update) with respect to the client connection information DB 12, receives an event from the client controller 17 and makes a request to the client controller 17, and determines a session partner. For the determination of a session partner, a predetermined process is performed.

This predetermine process is, for example, a process to determine, when giving an instruction to establish a session between two VC clients, which VC client an instruction will be given.

An example of this predetermined process is a process of selecting one having a smaller client identification number and the like, or giving an instruction to a VC client that is instructed in the same combination as the previous time.

The client session controller 15 functions as a session state detection unit which reads out information from the client connection information DB 12 and detects a session state between the VC clients PC-1 to PC-3.

The client session controller 15 functions as a controller which establishes or terminates, according to a detected line state between telephone terminals, connection for image data communication between VC clients arranged corresponding to the telephone terminals.

The client session controller 15 reads out information (a connected terminal list) from the call information DB 11 and detects connection, hold, or disconnection of a call between telephone terminals.

At the same time, the client session controller 15 reads out information (VC client list) from the client connection information DB 12 and detects a current session state (which client has established a session with which client, and so on) among the VC clients PC-1 to PC-3.

Then, the client session controller 15 instructs to establish or terminate a session among the VC clients PC-1 to PC-3 corresponding to the telephone terminals so as to synchronize with the detected connection, hold, or disconnection state between the telephone terminals.

Specifically, the client session controller 15 functions as a controller which specifies a target of instruction from the client computers PC-1 to PC-3 corresponding to the telephone terminals Tel-1 to Tel-3 based on a line connection state among the telephone terminals Tel-1 to Tel-3, a session state among the client computers PC-1 to PC-3, correspondence information (ID and telephone number of VC clients) between client computers and telephone terminals in the client information-DB 10.

The client session controller 15 functions as a controller which instructs to establish or terminate a session among the client computers PC-1 to PC-3 according to a line state between specified ones among the telephone terminals Tel-1 to Tel-3.

The ID of a VC client is one complying with or similar to URI (uniform Resource Identifiers) of SIP. For example, it is expressed as “SIP:telephone number@IP address of belonging VC server” or the like.

The client session controller 15 reads out information (a connected terminal list) of a connection state among the telephone terminals Tel-1 to Tel-3 in the call information DB 11 and information (a VC list) of session states of the VC clients PC-1 to PC-3 in the client connection information DB 12 and compares them with each other.

As a result of the comparison, when ones among the VC clients PC-1 to PC-3 whose telephone terminals Tel-1 to Tel-3 are connected online have no session, the client session controller 15 instructs relevant ones among the VC clients PC-1 to PC-3 to hold a session.

When a call between ones among the telephone terminals Tel-1 to Tel-3 is terminated while a session is being held between corresponding VC clients, the client session controller 15 instructs the relevant ones among the VC clients PC-1 to PC-3 to terminate the session.

When call connections among three or more of the telephone terminals Tel-1 to Tel-3 are detected, the client session controller 15 functions as a controller to generate a pair of IDs of every two telephone terminals among them (such as Tel-1 and Tel-2, Tel-1 and Tel-3, and Tel-2 and Tel-3).

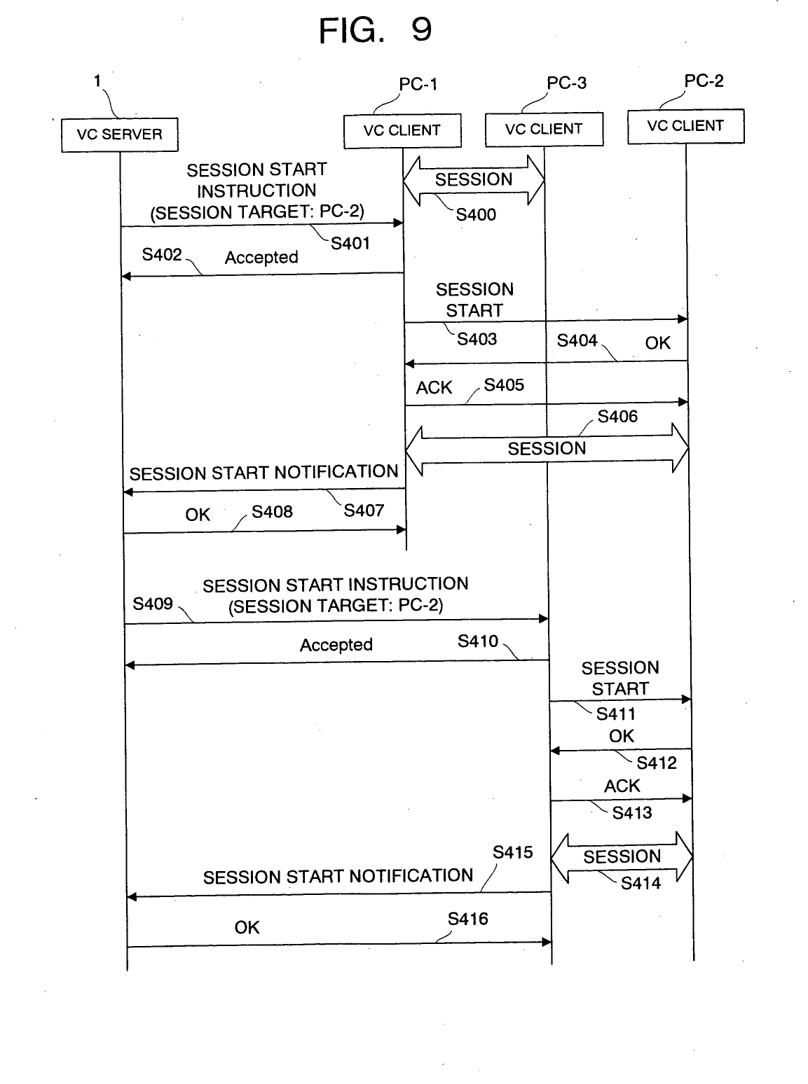

The client session controller 15 functions as a controller which establishes sessions in order between VC clients corresponding to the respective generated pairs. This operation will be described in detail in a communication sequence diagram in FIG. 9.

The protocol converter 16 performs TCP/IP communication with the VC clients PC-1 to PC-3 via the LAN I/F.

The protocol converter 16 controls an IP address with respect to a socket.

On the protocol converter 16, there is mounted SIP (Session Initiation Protocol) for performing communication in the application layer such as control of sessions and registration of client information.

Between the VC clients PC-1 to PC-3 and the VC server, communication via the LAN 5 is performed with TCP/IP provided in each OS for transmitting/receiving a message of SIP.

In other words, the protocol converter 16 performs mutual conversion of a message (data) of SIP into a TCP/IP packet or vice versa.

The client controller 17 performs transmission/reception of a message to/from the VC clients PC-1 to PC-3, notification to the client session controller 15, reception of a request from the client session controller 15, request to the client information management unit 18, reception of a message from the protocol converter 16, and so on.

In other words, the client controller 17 passes an instruction from the client session controller 15 to the protocol converter 16.

The client controller 17 also passes a notification received from the VC clients PC-1 to PC-3 to the client session controller 15 and the client information management unit 18.

The client information management unit 18 receives from the client controller 17 VC client information (a client information ID and the number of a corresponding telephone terminal) that is transmitted/received between the client session controller 15 and each of the VC clients PC-1 to PC-3 during a login request and VC client information transmitted/received during a log off request, and performs a data edit operation (new registration, delete, and update) with respect to the client information DB 10.

The authentication unit 19 refers to user authentication information registered in advance in the user authentication information DB based on login information such as a user ID and a password included in a login request received from the VC clients PC-1 to PC-3, and performs user authentication of whether or not the login information matches the contents of the user authentication information.

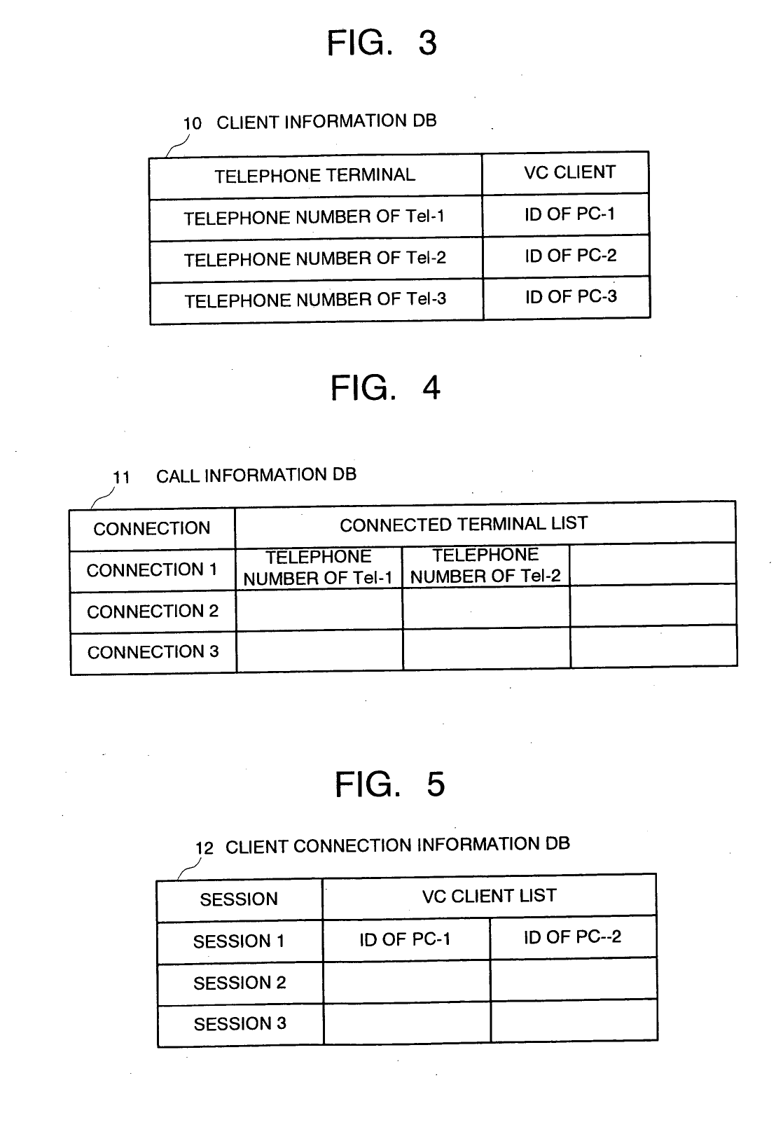

As shown in FIG. 3, in the client information DB 10, respective client information (client IDs and telephone numbers of corresponding telephone terminals) received from the VC clients PC-1 to PC-3 is stored (registered) in correspondence.

In the client information DB 10, there is registered (stored) information of correspondence relationship (correspondence information) between the VC clients PC-1 to PC-3 which are able to join a television conference and the telephone terminals Tel-1 to Tel-3.

Specifically, the client information DB 10 functions as a storage unit which stores correspondence between the client IDs (identification information) of the VC clients PC-1 to PC-3 located at positions corresponding to the respective telephone terminals Tel-1 to Tel-3 and the telephone numbers (identification information) of the telephone terminals Tel-1 to Tel-3.

In the call information DB 11, as shown in FIG. 4, when there is a group of telephone numbers of telephone terminals whose calls are actually connected (connected online), or when the telephone terminal Tel-1 and the telephone terminal Tel-2 are connected online for example, a record, “connection 1” for instance, is created as a connection name, and in this record the telephone number of the telephone terminal Tel-1 and the telephone number of the telephone terminal Tel-2 are stored in correspondence.

The call connections may exist not only between two telephone terminals but among three or more telephone terminals, and in such a case, a field for the telephone number of a telephone terminal is added in order in the record.

When all calls in the record are disconnected, the record itself such as the “connection 1” is deleted.

Note that although the telephone number is used as information for identifying a telephone terminal, it may otherwise be a call ID or the like, or may be a path (A-A1: a telephone terminal A1 belonging to an A group, or the like) in grouped telephone terminals.

As shown in FIG. 5, in the client connection information DB 12, a pair of IDs of ones actually holding a session among the VC clients PC-1 to PC-3 is stored.

When a session is held between computers, it is done such that one computer sends a request to another computer one to one, and thus it is always done in a pair.

As in this example, when a session is held between the VC client PC-1 and the VC client PC-2, a record such as “session 1” as a session name is created in the client connection information DB 12.

Then, in the record “session 1,” the ID of the VC client PC-1 and the ID of the VC client PC-2 are stored in correspondence as a VC list.

In communication involving three or more telephone terminals, each of the VC clients PC-1 to PC-3 holds a session individually, so that the record of pairs of IDs increases.

Hereinafter, the operations of this visual communication system will be described with reference to FIG. 6 to FIG. 9.

In the case of this visual communication system, when the telephone terminals Tel-1 to Tel-3 are operated, respective behaviors of the telephone terminals Tel-1 to Tel-3 are detected by the exchange 3, and an event signal is transmitted from the exchange 3 to the VC server 1 via the LAN 5 and is received by the VC server 1.

Here, the event signal transmitted from the exchange 3 and received by the VC server 1 with respect to operations of the telephone terminals Tel-1 to Tel-3 will be described.

As shown in FIG. 6 for example, it is assumed that the event signal is in the form of an event name (a telephone number and a state), and the telephone number of a calling side telephone terminal is “200,” and the telephone number of a receiving side telephone terminal is “201.”

In this case, when the receiver is picked up from the terminal main body and off-hooked by a user on the calling side telephone terminal, an event signal “talking” (200: talking) is received.

Thereafter, when a ringing operation takes place on the receiving side telephone terminal, an event signal “ringing” (200: talking, 201: ringing) is received.

After the ringing operation, when the receiver is picked up from the terminal main body and off-hooked by a user on the receiving side telephone terminal, an event signal “talking” (200: talking, 201: talking) is received.

Thereafter, when the receiver is put down on the terminal main body and on-hooked on the receiving side telephone terminal after a call is performed between both the telephone terminals, an event signal “dropped” (200: talking, 201: dropped) is received.

Thereafter, when the receiver is put down on the terminal main body and on-hooked on the calling side telephone terminal, an event signal “dropped” (200: dropped) is received.

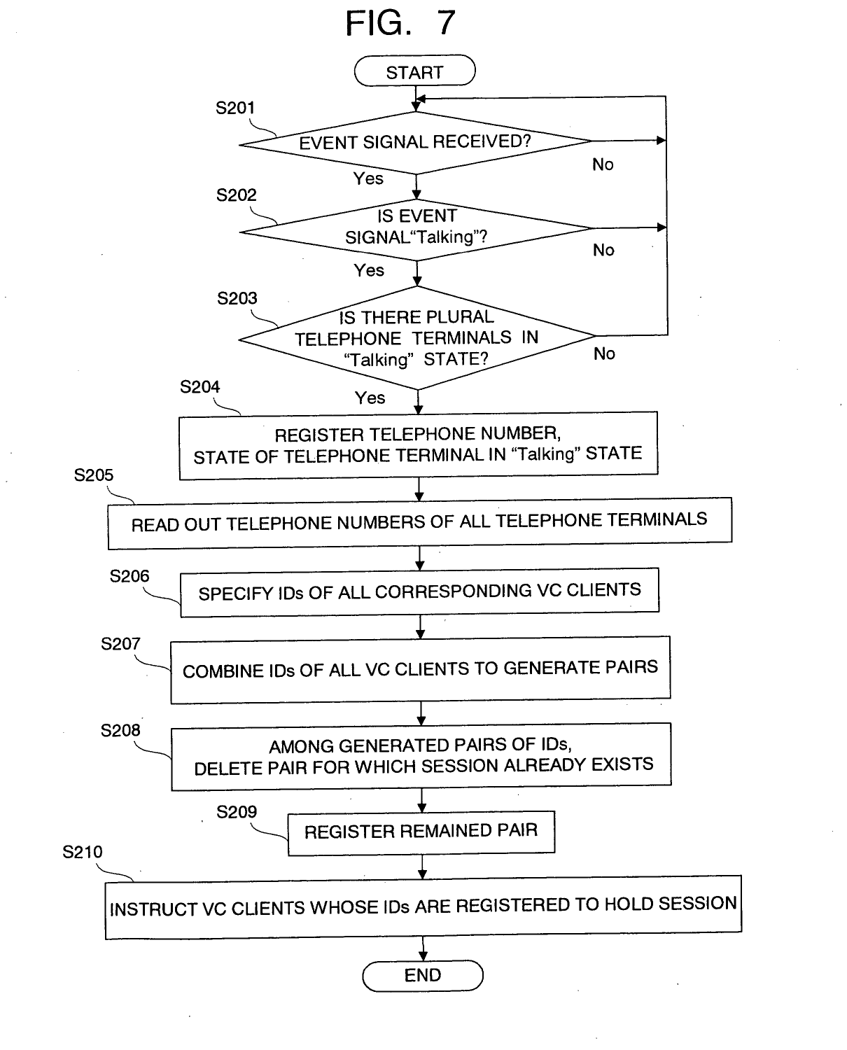

In the VC server 1, an event signal is received by the call management unit 14 via the LAN I/F 13 (Yes in Step 201 in FIG. 7; hereinafter, “step” is referred to as S, and this Step 201 is referred to as S201).

The call management unit 14 extracts the contents of the event signal, which are event name, telephone number, and state, and judges whether the state is “talking” or not among them (S202).

If it is not “talking” as a result of the judgment (No in S202), the call management unit 14 discards this event signal and waits for reception of the next event signal.

If it is “talking as a result of the judgment (Yes in S202), the call management unit 14 refers to the call information DB 11 and judges whether there is two or more telephone terminals in a “talking” state (S203) in the connected terminal list.

If there are two or more telephone terminals in a “talking” state exist as a result of this judgment (Yes in S203), the call management unit 14 additionally registers the telephone numbers of new telephone terminals in the connected terminal list in the record of corresponding connection names in the call information DB 11 (S203).

Specifically, if there are two or more telephone terminals in a “talking” state exist as a result of this judgment (Yes in S203), the call management unit 14 obtains the connection name or the connection group number and correlates the telephone number and the state of a telephone terminal in a “talking” state with the connection name or the connection group number and registers them in the call information DB 11.

In other words, the call management unit 14 adds the telephone number of a new telephone terminal to the connected terminal list and updates the call information DB 11.

On the other hand, if there is no more than one telephone terminal in a “talking” state (No in S203), the call management unit 14 creates a new record of connection name in the call information DB 11, registers the telephone number of the new telephone terminal in the connected terminal list, notifies a changed connection name or connection group number to the client session controller 15 thereafter, and waits for reception of the next event signal.

Subsequently, the client session controller 15 reads out telephone numbers of all telephone terminals from the call information DB 11 using the connection group number passed from the call management unit 14 as a key (S205).

The client session controller 15 also reads out all corresponding client information (pairs of telephone numbers and IDs of VC clients) from the client information DB 10.

The client session controller 15 then specifies IDs of VC clients which are video connection targets corresponding to the telephone terminals connected online based on the respective read information (the telephone numbers of all the telephone terminals which are connected online and client information of all the clients which can be video-connected) (S206).

The client session controller 15 combines each two IDs among the specified IDs of the VC clients to generate pairs of IDS of all the VC clients (S207) and stores them in a connection memory.

Note that when call connections among three or more of the telephone terminals Tel-1 to Tel-3 are detected, the client session controller 15 generates a pair of IDS of every two telephone terminals among them (such as Tel-1 and Tel-2, Tel-1 and Tel-3, and Tel-2 and Tel-3).

Moreover, the client session controller 15 refers to the client connection information DB 12 and reads out a pair of IDS which already hold a session and compares the read pair of IDS in a session with pairs of IDS stored in the memory.

As a result of comparison, if there exists a pair of IDs for which a session already exists in the connection memory, the client session controller 15 deletes this pair from the connection memory (S208) and stores this pair in a deletion memory.

Specifically, the client session controller 15 checks the client connection information DB 12 for each combination of all generated pairs of IDS of VC clients, and if a session already exists, the relevant pair is deleted from all the generated pairs.

Note that the order of pairs of IDs is not taken into consideration, and only a combination of pairs with each other is used as a criterion for judgment.

After the deletion, the client session controller 15 registers the pair of IDS that remains in the connection memory to the client connection information DB 12 (S209), and deletes the pair of IDs that remains in the deletion memory from the client connection information DB 12.

After the registration, with respect to each combination of pairs of IDs of VC clients, the client session controller 15 selects either one of the pairs.

The client session controller 15 sends to the client controller 17 a message of instructing the VC client selected as a session start target to hold a session with the other VC client, that is, a session start instruction message (S210).

Regarding the selection of VC clients, it is conceivable to select one that satisfies a predetermined condition (such as a VC client located at the same position as the caller side telephone terminal, a VC client on the not-charged side, and so on), to give priority to the previous instruction contents, or the like.

The client controller 17 passes the session start instruction message received from the client session controller 15 to the protocol converter 16.

The protocol converter 16 converts the session start instruction message passed from the client controller 17 into an IP packet and transmits it to a relevant VC client via the LAN 5.

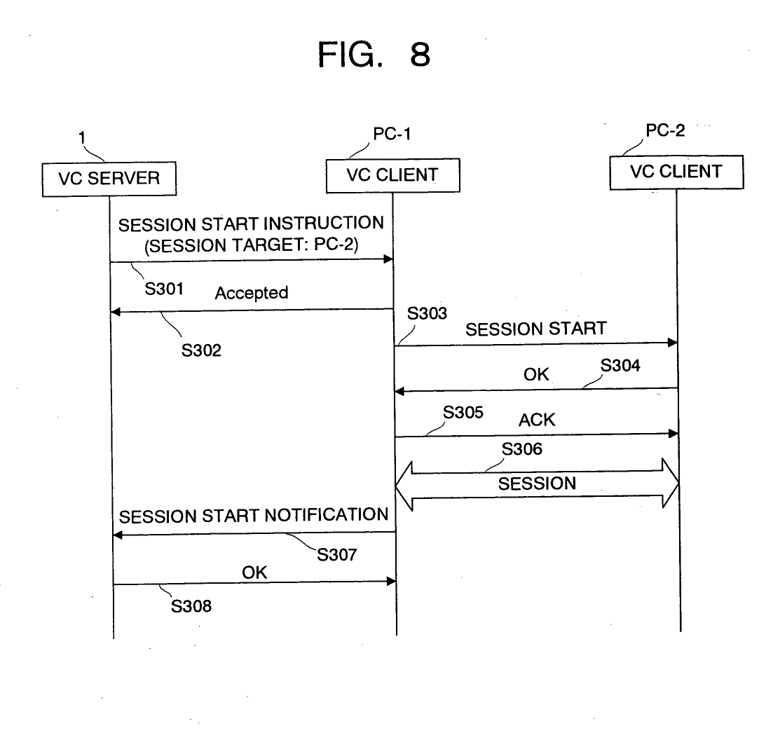

Hereinafter, a procedure of starting a video session between two VC clients will be described with reference to a communication sequence diagram of FIG. 8. First, a flow (condition) until the start of this communication sequence will be described.

A call is made from the telephone terminal Tel-1 with the telephone number “200” correlated to the VC client PC-1 and received by the telephone terminal Tel-2 with the telephone number “201” correlated to the VC client PC-2 which is then off-hooked, and thus these terminals are connected online with each other via the exchange 3 and a voice call is started.

For example, it is assumed that a VC client as the session origin that is instructed to hold a session by a session control operation for VC clients carried out by the VC server 1 is the VC client PC-1, and the VC client PC-2 is selected and instructed as a VC client as the session target (session partner).

In this case, a packet including a message of session start instruction from the VC server 1 is received by the VC client PC-1 via the LAN 5 (S301).

Then, in the VC client PC-1, the CPU returns a message “accepted” as a response to the received packet (S302).

Also, the CPU extracts a message of instruction included in the received packet. If the message of instruction is, for example, a message instructing the VC client PC-2 to hold a session, the CPU transmit a request for holding a session, namely, a session start request, to the VC client PC-2 (S303).

In the VC client PC-2, the CPU which received the session start request returns a message “OK” to the VC client PC-1 (S304).

In the VC client PC-1, the CPU which received the message “OK” transmits “ACK” to the VC client PC-2 (S305).

In the VC client PC-2, when the CPU receives “ACK”, a session is established between the VC client PC-1 and the VC client PC-2 (S306).

After the session with the VC client PC-2 is established, the CPU of the VC client PC-1 transmits a session start notification to the VC server 1 (S307).

In the VC server 1, when the session start notification is received by the protocol converter 16, the protocol converter 16 returns a message “OK” to the VC client PC-1 (S308).

Next, a procedure of starting a video session among three VC clients will be described with reference to a communication sequence diagram in FIG. 9.

First, a flow (condition) until the start of this communication sequence will be described.

It is assumed that video communication is also held between the VC client PC-1 and the VC client PC-2 in the above-described example of FIG. 8 by holding a voice call between the telephone terminal Tel-1 with the telephone number “200” and the telephone terminal Tel-2 with the telephone number “201.”

Here, in an attempt of further adding a user (speaker) of the telephone terminal Tel-3 to hold a tripartite conference, the speaker of the telephone terminal Tel-1 presses a hold button of the telephone terminal Tel-1 to put a calling state with the telephone terminal Tel-2 on hold.

The exchange 3 detects this and transmits an event signal to the VC server 1, and in the VC server 1, the received event signal is received in the call management unit 14, which confirms the contents of the event signal.

As a result of this confirmation, if the event signal is one showing a hold of a call in a telephone terminal, the call management unit 14 adds a hold flag to a relevant record (connection name) in the call information DB 11.

The client session controller 15 reads call information from the call information DB 11 and terminates a session of the VC clients PC-1, PC-2 corresponding to the relevant telephone terminals Tel-1, Tel-2 of the connection name to which the hold flag is added.

In other words, the client session controller 15 terminates a connection for video data communication between the VC clients PC-1, PC-2 including the VC client PC-1 corresponding to the detected telephone terminal Tel-1 whose line state is detected as a hold state.

After the user (speaker) of the telephone terminal Tel-1 put the call to the telephone terminal Tel-2 on hold, the user dials the telephone number “202” of the telephone terminal Tel-3, the user (speaker) of the telephone terminal Tel-3 picks up the receiver responding to ringing so that the telephone terminal Tel-3 turns to an off-hook state, and thereby a calling state occurs between the telephone terminals.

At this time, video communication is started between the VC client PC-1 and the VC client PC-3 correlated by the client information DB 10.

By pressing the hold button of the telephone terminal Tel-1 in order to add the telephone terminal Tel-1 whose calling state has been on hold to have the tripartite conference, the tripartite conference by voice becomes possible among the three speakers at the telephone terminals Tel-1, Tel-2, and Tel-3.

At this time, by the call management unit 14 which received the event signal sent from the exchange 3 to the VC server 1, the respective telephone numbers of the telephone terminals Tel-1, Tel-2 and Tel-3 are registered in the same connection group in the call information DB 11.

At this time, in the client connection information DB 12, the session between the VC client PC-1 and the VC client PC-3 just before the tripartite conference is carried out is stored.

Therefore, in the VC server 1, the client session controller 15 reads out and compares information in the call information DB 11 and in the client connection information DB 12, and thereby judges that sessions need to be newly held between the VC client PC-1 and the VC client PC-2 and between the VC client PC-3 and the VC client PC-2.

In this case, the client session controller 15 of the VC server 1 instructs the VC client PC-1 to start a session with the VC client PC-2.

Thereafter, the client session controller 15 instructs the VC client PC-3 to start a session with the VC client PC-2.

When a message of instructing to hold a session, namely, a session start instruction is issued from the client session controller 15 to the VC client PC-1, it is sent to the client controller 17, and the client controller 17 which received this message passes it to the protocol converter 16.

The protocol converter 16 transmits via the LAN 5 a packet including the message of session start instruction to the VC client PC-1 to be the origin of holding a session.

Then, the packet including the message of session start instruction from the VC server 1 is received by the VC client PC-1 via the LAN 5 (S401).

In the VC client PC-1, the CPU returns a message “accepted” as a response to the received packet (S402).

Also, the CPU extracts a message of instruction included in the received packet.

If the message of instruction is, for example, a message instructing the VC client PC-2 to hold a session, the CPU transmit a request for holding a session, namely, a session start request, to the VC client PC-2 (S403).

In the VC client PC-2, the CPU which received the session start request returns a message “OK” to the VC client PC-1 (S404).

In the VC client PC-1, the CPU which received the message “OK” transmits “ACK” to the VC client PC-2 (S405).

In the VC client PC-2, when the CPU receives “ACK”, a session is established between the VC client PC-1 and the VC client PC-2 (S406).

After the session with the VC client PC-2 is established, the CPU of the VC client PC-1 transmits a session start notification to the VC server 1 via the LAN 5 (S407).

In the VC server 1, when the session start notification from the LAN 5 is received by the protocol converter 16, the protocol converter 16 returns a message “OK” to the VC client PC-1 (S408).

When a message of instructing to hold a session, namely, a session start instruction is issued from the client session controller 15 to the VC client PC-3, it is sent to the client controller 17, and the client controller 17 which received this message passes it to the protocol converter 16.

The protocol converter 16 transmits via the LAN 5 a packet including the message of session start instruction to the VC client PC-3 to be the origin of holding a session.

Then, the packet including the message of session start instruction from the VC server 1 is received by the VC client PC-3 via the LAN 5 (S409).

In the VC client PC-3, the CPU returns a message “accepted” as a response to the received packet (S410).

Also, the CPU extracts a message of instruction included in the received packet.

If the extracted message of instruction is, for example, a message instructing the VC client PC-2 to hold a session, the CPU transmit a request for holding a session, namely, a session start request, to the VC client PC-2 (S411).

In the VC client PC-2, the CPU which received the session start request returns a message “OK” to the VC client PC-3 (S412).

In the VC client PC-3, the CPU which received the message “OK” transmits “ACK” to the VC client PC-2 (S413).

In the VC client PC-2, when the CPU receives “ACK”, a session is established between the VC client PC-3 and the VC client PC-2 (S414).

After the session with the VC client PC-2 is established, the CPU of the VC client PC-3 transmits a session start notification to the VC server 1 via the LAN 5 (S415).

In the VC server 1, when the session start notification from the LAN 5 is received by the protocol converter 16, the protocol converter 16 returns a message “OK” to the VC client PC-1 (S416).

Specifically, when call connections among three or more of the telephone terminals Tel-1 to Tel-3 are detected, the client session controller 15 generates a pair of IDs of every two telephone terminals among them (such as Tel-1 and Tel-2, Tel-1 and Tel-3, and Tel-2 and Tel-3), and establishes sessions between the VC clients corresponding to the respective pairs in order.

Thus, according to the visual communication system of this embodiment, when an event signal (call information event) is received from the exchange 3, the call management unit 14 of the VC server 1 checks telephone numbers and a change in state included in event information therein. When at least two telephone numbers among them are in a “talking” state, the call management unit 14 judges (detects) that their telephone lines are connected with each other, and registers the received telephone numbers in correspondence in the call information DB 11, there by enabling reference of each other's state.

The client session controller 15 reads out the line states between the telephone terminals in the call information DB 1i and session states of VC clients in the client connection information DB 12 and compares them, and when no session is held among VC clients whose telephone terminals are connected, the client session controller 15 instructs relevant VC clients to hold a session according to the corresponding information in the client information DB 10.

Also, when a call between telephone terminals is disconnected while a session is being held between corresponding VC clients, the client session controller 15 instructs the relevant VC client to terminate the session according to the corresponding information in the client information DB 10.

Accordingly, without preparing dedicated telephones, users become able to start a television conference automatically by performing an ordinary telephone operation.

It should be noted that the present invention is not limited to the above-described embodiment.

In the above-described embodiment, the telephone terminals Tel-1 to Tel-3 connected to the exchange 3 are ones using the general telephone lines 7, but IP telephones which can be connected via LAN or USB may be used.

In the above-described embodiment, the exchange 3 and the VC server 1 are described as separate hardware, but their respective functions may be provided within the same cabinet.

Moreover, besides the connection via the LAN 5, the exchange 3 and the VC server 1 may be connected via a serial connection, and thus the form of connection is not limited.

### Other Embodiments

The present invention is not limited to some embodiments described herein with reference to the drawings and may be expanded and modified, and any expansion and modification within the scope of the claims below are all embraced in the technical scope of the present invention.

What is claimed is:

1. A visual communication server coupled to an exchange which controls a line connection between telephone terminals and to client computers arranged corresponding to the respective telephone terminals so as to perform communication of visual data imaged by a camera, the visual communication server comprising:
a call information event receiving unit which receives from the exchange a call information event generated by a behavior of the telephone terminal;
a telephone terminal state detecting unit which detects a line state between the telephone terminals based on the call information event received by said call information event receiving unit; and
a controller which establishes or terminates according to the line state between the telephone terminals detected by said telephone terminal state detecting unit a session for the visual data communication between the client computers arranged corresponding to the telephone terminals.

2. The visual communication server as set forth in claim 1,
wherein said telephone terminal state detecting unit detects, when the call information event received by said call information event receiving unit is one showing a line connection between telephone terminals, a line state between the telephone terminals as a connected state, and
wherein said controller establishes a session for visual data communication between client computers with each other corresponding to the respective telephone terminals for which the line state is detected as a connected state by said telephone terminal state detecting unit.

3. The visual communication server as set forth in claim 1,
wherein said telephone terminal state detecting unit detects, when the call information event received by said call information event receiving unit is one showing termination of a line connection, a line state between relevant ones among the telephone terminals as a disconnected state, and
wherein said controller terminates a session for visual data communication between client computers including client computers that correspond to the telephone terminals for which the line state is detected as a disconnected state by said telephone terminal state detecting unit.

4. The visual communication server as set forth in claim 1,
wherein said telephone terminal state detecting unit detects, when the call information event received by said call information event receiving unit is one showing a temporary hold, a line state between relevant ones among the telephone terminals as a held state, and
wherein said controller terminates a session for visual data communication between client computers including client computers that correspond to the telephone terminals for which the line state is detected as a held state by said telephone terminal state detecting unit.

5. The visual communication server as set forth in claim 1,
wherein when line connections among three or more telephone terminals are detected by said telephone terminal state detecting unit, said controller generates a pair of every two telephone terminals among the telephone terminals and establishes sessions in order between client computers corresponding to each pair.

6. A visual communication program configured to execute processes in a visual communication server coupled to an exchange which controls a line connection between telephone terminals and to client computers arranged corresponding to the respective telephone terminals so as to perform communication of visual data imaged by a camera, the visual communication program comprising functions where the visual communication server:
receives from the exchange a call information event generated by a behavior of the telephone terminal;
detects a line state between the telephone terminals based on the received call information event; and
establishes or terminates according to the detected line state between the telephone terminals a session for the visual data communication between the client computers arranged corresponding to the telephone terminals.

7. The visual communication program as set forth in claim 6, further comprising functions where the visual communication server:
detects, when the received call information event is one showing a line connection between telephone terminals, a line state between the telephone terminals as a connected state; and
establishes a session for visual data communication between client computers with each other corresponding to the respective telephone terminals for which the line state is detected as a connected state.

8. The visual communication program as set forth in claim 6, further comprising functions where the visual communication server:
detects, when the received call information event is one showing termination of a line connection, a line state between relevant ones among the telephone terminals as a disconnected state; and
terminates a session for visual data communication between client computers including client computers that correspond to the telephone terminals for which the line state is detected as a disconnected state.

9. The visual communication program as set forth in claim 6, further comprising functions where the visual communication server:
detects, when the received call information event is one showing a temporary hold, a line state between relevant ones among the telephone terminals as a held state; and
terminates a session for visual data communication between client computers including client computers that correspond to the telephone terminals for which the line state is detected as a held state.

10. The visual communication program as set forth in claim 6, further comprising functions where the visual communication server:
generates, when line connections among three or more telephone terminals are detected, a pair of every two telephone terminals among the telephone terminals; and
establishes sessions in order between client computers corresponding to each pair.

11. A visual communication method for a visual communication server coupled to an exchange which controls a line connection between telephone terminals and to client computers arranged corresponding to the respective telephone terminals so as to perform communication of visual data imaged by a camera, the visual communication method comprising:
receiving from the exchange a call information event generated by a behavior of the telephone terminal;
detecting a line state between the telephone terminals based on the received call information event; and
establishing or terminating according to the detected line state between the telephone terminals a session for the visual data communication between the client computers arranged corresponding to the telephone terminals.

12. The visual communication method as set forth in claim 11, further comprising:
detecting, when the received call information event is one showing a line connection between telephone terminals, a line state between the telephone terminals as a connected state; and
establishing a session for visual data communication between client computers with each other corresponding to the respective telephone terminals for which the line state is detected as a connected state.

13. The visual communication method as set forth in claim 11, further comprising:
detecting, when the received call information event is one showing termination of a line connection, a line state between relevant ones among the telephone terminals as a disconnected state; and
terminating a session for visual data communication between client computers including client computers that correspond to the telephone terminals for which the line state is detected as a disconnected state.

14. The visual communication method as set forth in claim 11, further comprising:
detecting, when the received call information event is one showing a temporary hold, a line state between relevant ones among the telephone terminals as a held state; and
terminating a session for visual data communication between client computers including client computers that correspond to the telephone terminals for which the line state is detected as a held state.

15. The visual communication method as set forth in claim 11, further comprising:
generating, when line connections among three or more telephone terminals are detected, a pair of every two telephone terminals among the telephone terminals; and
establishing sessions in order between client computers corresponding to each pair.
